(19) United States
(12) Patent Application Publication
(10) Pub. No.: US 2014/0038266 A1
(43) Pub. Date: Feb. 6, 2014

(54) OIL ABSORBENT COMPOSITION

(71) Applicant: The Forestry Commission, Edinburgh (GB)

(72) Inventors: Franciscus Antonius Anna Maria De Leij, Rustington (GB); James Stratford, Guildford (GB); Tony Hutchings, Farnham (GB)

(73) Assignee: The Forestry Commission, Edinburgh (GB)

(21) Appl. No.: 14/045,347

(22) Filed: Oct. 3, 2013

Related U.S. Application Data
(63) Continuation of application No. PCT/GB2012/050683, filed on Mar. 28, 2012.

(30) Foreign Application Priority Data
Apr. 8, 2011 (GB) 1105961.5
Oct. 11, 2011 (GB) 1117521.3

(51) Int. Cl. B01J 20/30; C09K 3/32; B01J 20/20; C02F 1/28; B09C 1/08

(52) U.S. Cl. CPC B01J 20/3078; C02F 1/288; B09C 1/08; B01J 20/20; C09K 3/32
USPC 435/252.5; 210/694; 210/665; 405/264; 502/401; 502/418; 502/426; 502/406; 502/416; 435/253.3; 435/252.1; 252/175; 252/181; 252/178

(57) ABSTRACT

The invention relates to a method of preparing an oil absorbent composition. The method comprises heating and then de-mineralising a precursor plant material under conditions suitable to produce an oil absorbent composition comprising charcoal. The invention extends to oil absorbent compositions per se, such as charcoal-based compositions, and to various uses of the compositions for efficiently and rapidly absorbing spilled oil, for example from water surfaces, or from bituminous sands.

The present invention relates to oil absorbent compositions, such as charcoal-based compositions, and to methods of making such oil absorbent materials. The invention extends to various uses of the compositions for efficiently and rapidly absorbing spilled oil, for example from water surfaces, or from bituminous sands.

Oceans, soils, beaches, sea-bed sands and estuarine muds are commonly impacted by oil spills causing significant environmental problems. Oil spill disaster responses generally consist of three main measures, including containment of the spill using booms, oil dilution and dispersion, and/or oil removal and recovery. It is estimated that conventional methods of oil recovery, such as physical methods, including the use of skimmers and pumping to recover the oil after an accidental spill, rarely recover more than 10-15% of the spilled oil. Therefore, the second line of defence is the use of dispersants or emulsifiers to break up the oil into small droplets that become dispersed within the water. However, the use of dispersants and emulsifiers for the clean-up of oil spills has been widely criticised because such substances are themselves often toxic to aquatic life, and in some cases even carcinogenic, further exacerbating the toxicity of the oil.

Although feathers, wool and peat have been suggested as oil absorbents, their large-scale use is either impractical, or environmentally unsustainable in the case of peat. The use of absorbents to ‘mop up’ oil spills is therefore unusual and the only commercially available product on the market for this purpose is a product called ‘Sea-sweep’, and is described in U.S. Pat. No. 5,110,785. ‘Sea-sweep’ is produced from pine wood (Pinus spp.) and is claimed to be able to absorb 3.5 times its own weight in oil. The products' effectiveness is claimed to be due to its hydrophobic nature and its tubular internal structure. The tubular structure of the wood derived material is the result of the xylem channels in wood. Hydrophobicity is imparted via heating the wood at relatively low temperatures, i.e. no more than 380° C. However, a significant problem with this process is that, at such low temperatures, the wood from which these products are derived degrades partly into hydrophobic molecules, i.e. creosotes that consist of more than 90% poly-aromatic hydrocarbons (PAHs). Hence, although these molecules are hydrophobic, they are also toxic.

U.S. Pat. No. 4,605,640, on the other hand, describes the use of cellulose-containing substrates that are impregnated with fatty quarternary ammonium salts, such as hexadecyl-trimethyl ammonium bromide to make the materials hydrophobic. However, these materials are not heated during their preparation, and their oil absorption capabilities are comparatively poor.

Bituminous sands, also known as oil sands or tar sands, are a type of petroleum deposit. The sands contain naturally occurring mixtures of sand, clay, water, and a dense and extremely viscous form of petroleum, technically referred to as bitumen (or colloquially “tar” due to its similar appearance, odour and colour). Oil sands are found in large amounts in many countries throughout the world, but are found in extremely large quantities in Canada and Venezuela. Because extra-heavy oil and bitumen flow very slowly, if at all, towards producing wells under normal reservoir conditions, the sands must be extracted by strip mining or the oil made to flow into wells by in situ techniques, which reduce the viscosity by injecting steam, solvents, and/or hot air into the sands. Most commonly, the oil is extracted using hot water and dispersants that allows separation of the bitumen from the sand and clay. As a rule, around four barrels of water are used to extract one barrel of bitumen. This process therefore generates vast quantities of processed water that is contaminated with oil. This water has to be stored in lagoons, known as ‘tailing ponds’. There is therefore a need for the water in these tailing ponds to be cleaned up and for the remaining oil to be extracted.

The inventors focused their research on a wide variety of plant-derived, cellulosic materials, and have devised a more efficient method for preparing an oil absorbent composition, which exhibits superior oil absorbent properties compared to products currently on the market.

According to a first aspect of the invention, there is provided a method of preparing an oil absorbent composition, the method comprising heating and then de-mineralising a precursor plant material under conditions suitable to produce an oil absorbent composition comprising charcoal.

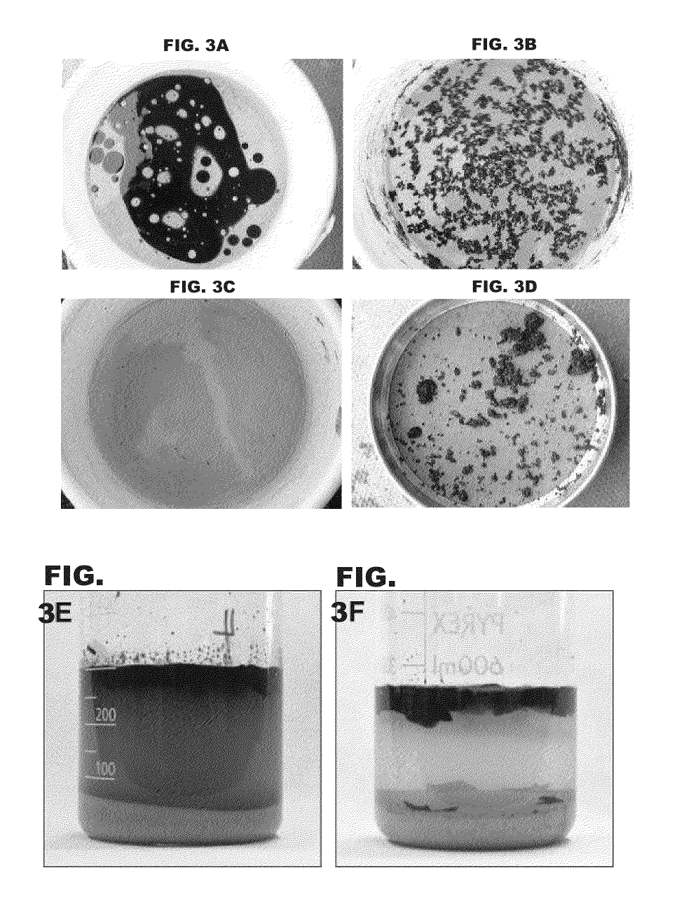

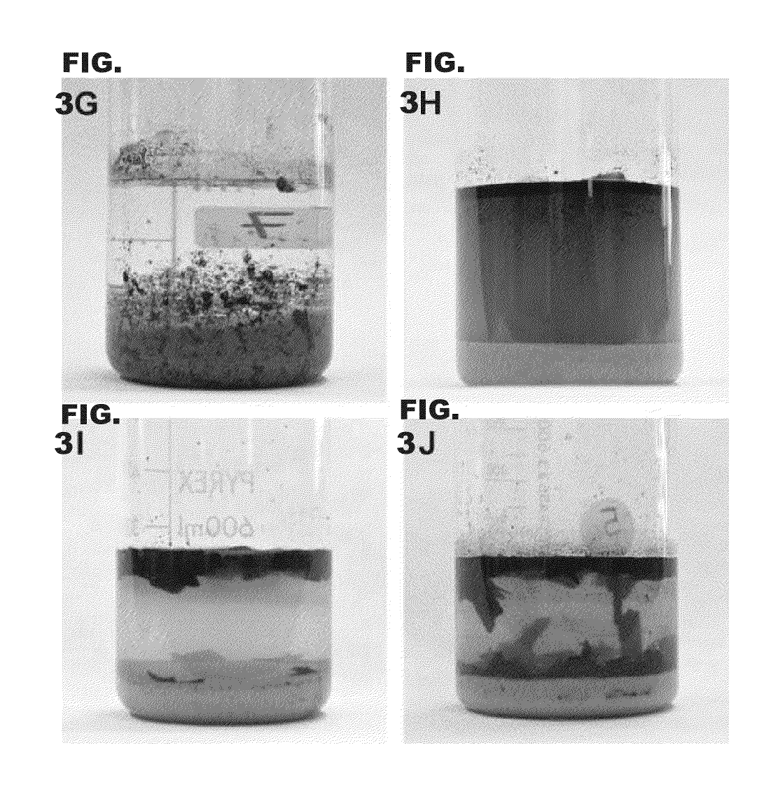

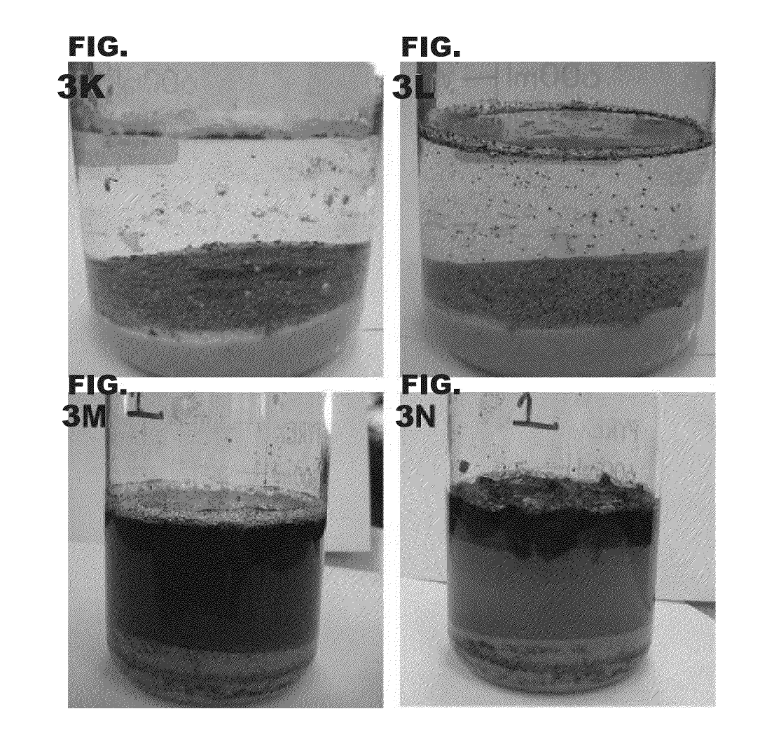

Surprisingly, the inventors observed that the method of the invention produces a charcoal composition, which exhibits extraordinarily high oil absorption capabilities. Indeed, as described in the Examples, and with reference to FIGS. 3A-3N, the inventors have observed that when contacted with oil, the absorbent composition that is produced by the method soaks up the oil within a matter of only seconds and the resultant oil/composition forms aggregates that float on the water surface. This prevents the oil from forming a thin oil film on the water surface. Instead, the aggregates can be easily removed from the water surface using conventional oil recovery methods such as skimmers, and booms. For example, when spread on top of an oil spill on water, the composition of the invention has been shown to absorb about 5-10 times its own weight in oil. This extraordinary ability to absorb oil to such an extent is achieved by using a demineralised charcoal that is derived from a plant material that preferably contains a high concentration of cellulose, but little or no lignin.

Whereas the thus created composition of the invention is exceptionally effective at absorbing oil when contacted with an oil spill, the composition can absorb water if contacted with water before being contacted with oil, making it less suitable as a barrier material for preventing the further spread of an oil spill. Furthermore, dispersed oil is not absorbed as efficiently either, because water that is taken up in the process can prevent oil absorption. In order to overcome this problem, the inventors have devised a treatment process that involves contacting the oil absorbent composition (once formed) with a water repellent substance.

Thus, the method may comprise contacting the oil absorbent composition with a water repellent substance. The water repellent substance may comprise lipid. For example, the repellent may be selected from the group consisting of: a fat; animal fat; plant fat; a fatty acid; a fatty acid ester; a fatty alcohol; a glyceride (mono-, di- or tri-glyceride); a hydrocarbon, such as a paraffin wax or tar; and mineral tar. One example of a plant fat is coconut butter. In embodiments where the composition is used to absorb (crude) oil, and if it were subsequently heated to desorb the volatile fractions, the non-volatile fractions (i.e. tars) would remain within the char, making the material highly hydrophobic and suitable for further use as an oil absorbent product.

Preferably, the water repellent substance may be paraffin wax, because of its availability, ease of application and non-toxicity. This wax is solid at room temperature, has a melting point of 56° C., and is a gas above 150° C. The oil absorbent composition (or char) may be impregnated with the water repellent substance, such as paraffin wax. During this process, the composition is contacted with hot paraffin gas that is sorbed therein allowing it to form a thin coating onto exposed charcoal surfaces. Once cooled, the paraffin solidifies and does not leach from the char.

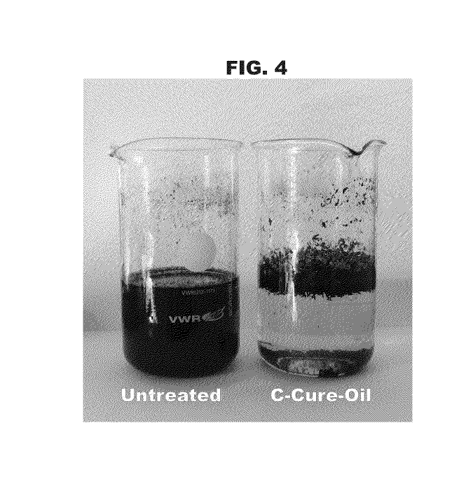

Accordingly, the water repellent substance may be contacted with the oil absorbent composition such that it is adsorbed into the micropores and/or mesopores of the absorbent composition. The water repellent substance may be in a gaseous form when it is contacted with the oil absorbent composition.

Whereas this process reduces the absorbing capacity of the material slightly, depending on how much water repellent substance is allowed to sorb, it has the considerable advantage that the resultant composition is now extremely hydrophobic so that it does not take up water. This means that it can be contacted with water before being contacted with oil without negatively affecting the oil absorption characteristics (see the results in Tables 5 and 6), making it eminently suitable to be used to absorb dispersed oil (see FIG. 4).

The oil absorbent composition formed by the above methods can be referred to as biochar. Once contacted with oil, the charcoal product forms oil containing aggregates that contain little or no water, and can therefore be easily recovered from the water using a sieve, suction sweeper or a fine-meshed net. Furthermore, since the composition does not take up significant amounts of water when applied to an oil spill, it allows efficient recovery of oil from water surfaces. In addition, because the composition is inert and consists of >90% of carbon (i.e. charcoal), it does not alter the properties of the absorbed oil. Accordingly, as described in the Examples, another advantage of the invention is that it is possible to readily recover the absorbed oil from the absorbent composition, which can be subsequently re-used.

The inventors have tested a wide variety of precursor plant materials, and have found that certain species of plants (i.e. both wood-derived and non-wood-derived) provide suitable precursor materials for use in the method of the first aspect, and can therefore be used to produce the highly efficacious charcoal-based oil absorbent. Preferably, the precursor material has a high cellulose content. The preferred source materials from which the composition is derived contain in general no lignin and the carbon fraction of these materials consists normally entirely of cellulose and hemi-cellulose.

Whereas source materials comprising mainly cellulose are preferred, low density woody materials that contain lignin will, when charred in the method of the invention, also make a good oil absorbent. Thus, in one embodiment, the precursor material may comprise, or be derived from, any woody plant material. For example, the precursor material may comprise, or be derived from, any hardwood species of plant, such as paulownia (Paulowniaceae spp.), aspen (Populus tremulis) and other poplar species such as cotton wood (Populus deltoides), balsa wood (Ochroma pyramidalis), butterwood (Platanus occidentalis), walnut (Juglans regia) or willow (Salex spp.). These species have typical wood densities of <500 kg m⁻³. Thus, it is preferred that the wood used to make the char has a low density.

Alternatively, the precursor material may comprise or be derived from a softwood species, preferably a low density softwood, for example a conifer (Picea spp.), pine (Pinaceae spp.) or cedar (Cedres spp.). The inventors were surprised to observe that char produced from paper and cardboard that were derived from wood pulp from which most if not all of the lignin had been removed displayed excellent oil absorption characteristics. Paper pulp can be derived from any wood, and is independent of its density. Accordingly, in one embodiment, the precursor material may be paper or cardboard, which may be contacted with a suitable binder such that it forms papier-mâché. A suitable binder may be carboxyl methyl cellulose. It will be appreciated that papier-mâché can be readily shaped into particles, such as granules, balls, pellets, sheets, etc. When the papier-mâché is subsequently heated in the method of the invention, the charred product still retains its shape, but becomes exceptionally absorbent, producing a material that is capable of absorbing over nine times its own weight in oil (see Table 2 in the results section).

In another embodiment, however, the precursor material may comprise non-woody plant material, or is derived from any non-woody plant species. Examples of non-woody plant materials, which may be used in the method, include those that are derived from a plant family selected from the group of families consisting of Brassicaceae, Poaceae, Amaranthaceae and Urticaceae. Examples of non-woody plant materials may include those derived from a genus selected from Brassica or Hordeum. Suitable species of non-woody plant material may include Brassica napus (oilseed rape), Hordeum vulgare (Barley), Triticum aestivum (Wheat), Secale cereale (Rye) Myscanthus (Elephant grass) or Zea mays (Maize).

Suitable precursor materials used in the method may be derived from any part of a plant, for example the trunk (i.e. inner core wood, sap wood or outer bark), a stem (i.e. inner or outer sections, or straw), the branches (inner or outer sections), a root (i.e. inner or outer sections), or a leaf, depending on whether it is derived from a hardwood, softwood or non-woody plant source. Preferably, the precursor material forming the absorbent composition comprises, or is derived from the stems of non-woody plants. The materials preferably contain mainly cellulose and hemi-cellulose.

The precursor material may be heated in the method of the first aspect to a temperature greater than 280° C., 300° C., 325° C., 350° C., 375° C., 400° C., 425° C., 450° C., 475° C., 500° C., 600° C., 700° C., 800° C., 900° C., or even greater than 1000° C. Pyrolysis temperatures greater than 800° C. are possible, but may lead to increasing amounts of carbon loss. Whereas carbon loss equates to a loss in product yield, a subsequent demineralisation step would restore any reduction in absorption capacity. The precursor material may be heated for a sufficient period of time for pyrolysis to be completed to produce the oil absorbent composition. For example, heating may be for a very brief period when using flash pyrolysis, for example a heating time of less than 1 minute. However, long heating times are possible, such as at least 10 minutes, at least 20 minutes, at least 30 minutes, at least 40 minutes, or at least 60 minutes. The material may be heated for at least 70 minutes, at least 80 minutes, at least 100 minutes, at least 110 minutes, or at least 120 minutes. In some embodiments, the material may be heated for more than 2 hours, such as 3, 4, 5 or even 6 hours or more. However, it should be understood that prolonged heating times are normally not necessary as long as all the material exposed to the heat is pyrolysed during the process. The length of time that the precursor material needs to be heated is dependent on how the material is presented (loose or baled for example) and the heating temperature. The greater the mass and the greater the density, the longer the material needs to be heated to allow the heat to penetrate and cause pyrolysis. Fine particles that are heated at a high temperature on the other hand will be charred within seconds.

As described in the examples, charring at about 450° C. until complete pyrolysis was achieved was found to be particularly effective. Accordingly, the precursor material may be heated at a temperature of between about 280° C. and about 1200° C., or between about 350° C. and about 800° C., or between about 400° C. and about 600° C. Preferably, the precursor material is heated under substantially anaerobic conditions.

The inventors were surprised to find that the de-mineralisation step carried out in the method of the first aspect resulted in a significant increase in oil absorption (i.e. by an astounding 50% for nettle straw) compared to when the precursor material was not demineralised. Not only does the demineralisation step result in an open porous structure within the charcoal into which oil may be absorbed, it also results in an absorbent composition which is much less dense than prior to the demineralisation step, and this reduction in density is believed to be particularly advantageous in treating oil spills, because the resultant composition floats on the treated water for longer periods of time, a characteristic that can be further enhanced by treating the composition with a water repellent substance, such as a lipid, or with for example paraffin wax. Accordingly, much more oil is absorbed by the absorbent composition than would be the case if the composition sank in the water, away from the oil floating on the surface. Furthermore, advantageously, the absorbent composition allows the recovery of valuable (i.e. useful) plant minerals during its production because of the de-mineralisation step.

The demineralisation step in the method may be achieved by contacting the precursor material with an acid, preferably following the heating step, for a suitable time period to allow for the removal of mineral ions from the previously heated precursor material. The acid may be any acid or a combination of acids, but sulphuric acid, hydrochloric acid or nitric acid, are all suitable. The pH of the solution should preferably be less than 4.0, more preferably less than 3.0, or preferably less than 2.0, and even more preferably less than 1.0. The lower the pH, the faster the demineralisation occurs and the less chance the minerals react with the acid, causing a significant pH rise of the solution. A strong acid is preferred. For example, nitric acid, in particular, is advantageous, because it allows the harvesting of valuable fertilisers from the heated material in the form of potassium nitrate, calcium nitrate and/or magnesium nitrate. The heat-treated precursor material may be contacted with the acid for several hours, and preferably at least 12, 24, 36 or 48 hours or more, depending on the acid strength, and the particle size of the char with longer contact times being necessary to dissolve the minerals if the char particles are larger. The acid wash treatment solubilises and removes the minerals within the pore structure of the precursor material, leaving behind an open porous structure, which lowers its density.

Removal of some elements (potassium, for example) from the oil absorbent composition can also be achieved by contacting the composition with a buffered solution having a neutral or a slightly acidic pH. Depending on the precursor material from which the absorbent composition is derived, this can lead to the removal of >50% of all the minerals therefrom. In many cases, (slightly) acidic buffers will be capable of removing all minerals from the absorbent composition.

Hence, in contrast to current materials that are used as oil absorbents, which have high mineral contents, the absorbent composition produced by the method of invention has a much lower mineral content because of the demineralisation step. The term “low mineral content” can refer to the concentration of elements or metal ions contained within the absorbent composition. For example, the composition may comprise a low concentration of alkali and/or alkaline earth metals. The concentration of alkali and/or alkali earth metals in the absorbent composition may be less than 3% (w/w), less than 2% (w/w), less than 1% (w/w), less than 0.5% or less than 0.1% of dried material. Drying may be carried out by warming at 100° C. for 28 hours, for example. Examples of alkali metal and alkaline earth metals may include potassium, calcium, sodium and/or magnesium.

Thus, the absorbent composition may have less than 2% (w/w), less than 1% (w/w) or less than 0.5% (w/w) potassium or potassium ions of dried material.

The absorbent composition may have less than 2% (w/w), less than 1% (w/w) or less than 0.5% (w/w) magnesium or magnesium ions of dried material.

The absorbent composition may have less than 2% (w/w), less than 1% (w/w) or less than 0.5% (w/w) calcium or calcium ions of dried material.

The absorbent composition may have less than 2% (w/w), less than 1% (w/w) or less than 0.5% (w/w) sodium or sodium ions of dried material.

The absorbent composition may comprise any combination of any of the foregoing elements (i.e. minerals) at any of the above-mentioned concentrations. Thus, the total concentration of potassium, magnesium, calcium and/or sodium may be less than 5% (w/w), less than 2.5% (w/w) or less than 1% (w/w) of dried material.

After the demineralisation step, the method may then comprise a step of separating the resultant absorbent composition from the acid, for example by filtration or centrifugation. Following separation from the acid, the method may further comprise adjusting the pH of the composition until the pH indicates that the majority of the acid has been substantially neutralised. This pH adjustment may be achieved, for example, by washing with water, or addition of a base. Slight acidity at this stage may be the result of carboxyl groups formed on the composition's surface during exposure to the acid during the acid wash. Once washed, the method may then comprise a drying step to provide the absorbent composition, which is then ready for use, as a product that can be applied directly onto an oil spill. However, a further treatment step where the composition is contacted with a water repellent substance (e.g. paraffin, wax, tar, fat etc.) may also be carried out.

According to a second aspect of the invention, there is provided an oil absorbent charcoal composition obtained from, or obtainable by, the method according to the first aspect.

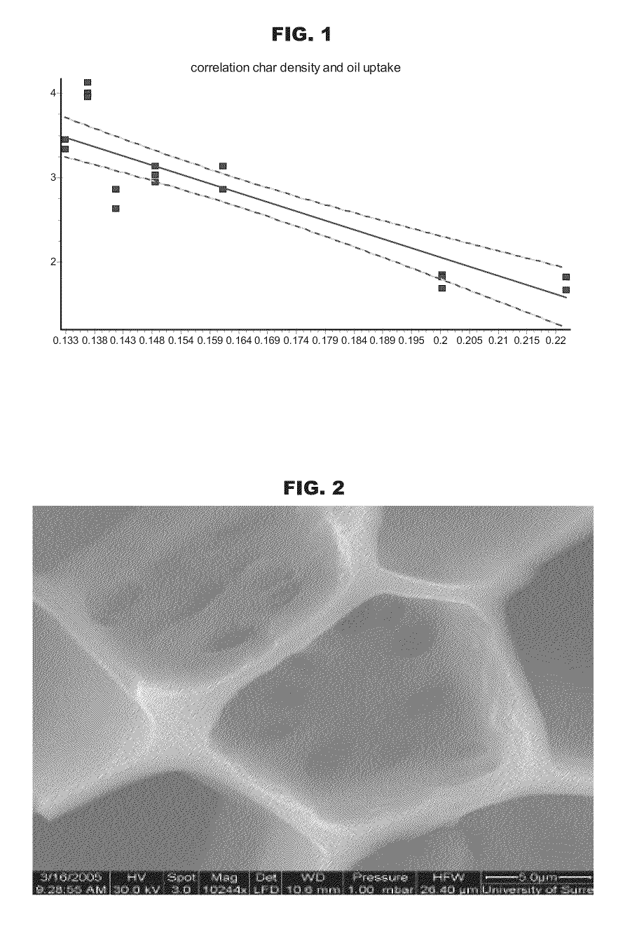

FIG. 1 shows that the lower the density of the absorbent material, the greater it's oil absorbing properties. Thus, the density of the absorbent composition may be less than 0.2 kg/L, 0.17 kg/L, 0.15 kg/L or less than 0.14 kg/L.

In a third aspect, there is provided an oil absorbent composition comprising charred charcoal comprising, or being derived from, plant material, wherein the charcoal has a density less than 0.2 kg/L and a mineral content of less than 10% of dried material.

The composition of the third aspect may also be obtainable by the method of the first aspect. The density of the absorbent composition of the third aspect may be less than 0.17 kg/L, 0.15 kg/L or less than 0.14 kg/L. The mineral content of the composition of the third aspect may be less than 10% alkali metal and alkaline earth metals, which may include potassium, calcium, sodium and/or magnesium.

Unlike prior art oil absorbent materials, there is no need for the compositions of the invention to have an internal network of tubes and capillaries. Instead, it is sufficient if the absorbent composition comprises a random, loosely arranged structure that contains voids into which oil can be absorbed. Indeed, the absorbent composition may be substantially macroporous. Pores in a sorbent derived from wood are called “macropores” if their pore size is greater than 500 nm in diameter. For practical purposes, pores having diameters in the range of 500 nm to 40,000 nm, more typically 500 to 20,000 nm, or 500 to 15,000 nm, may be classified as macropores.

Although not wishing to be bound by theory, the inventors believe that macropores are an example of voids that are present in the absorbent composition derived from wood, but that non-tubular, continuous and interconnecting voids that are present in charred papier-mâché, for example, are just as effective at absorbing oil as macro-pores. In fact, the inventors have surprisingly found that destruction of pores and voids by grinding the absorbent composition into a fine powder of less than 60 μm in diameter had no significant effect on the charcoal's ability to absorb oil (see examples, Table 1). This shows that, unlike what is claimed in the prior art, absorption is not governed by capillary action of an intact and continuous tubular structure, as found in charred wood. Once the composition of the invention is contacted with oil, the oil will cling to the available charcoal surfaces and form a film around them. Particles will subsequently attract each other forming a raft or aggregate that can be easily recovered. This means that more oil can be removed from the environment. This is because the absorbed oil in the composition is lighter than water resulting in the product and absorbed oil floating on the water surface where it can be easily removed. Because the composition does not react with the absorbed oil, the absorbed oil can be easily recovered, for example via centrifugation or by desorbing (e.g. volatilising) the oil by applying heat to the ‘spent’ product that volatiles the absorbed oils and greases Finally, the spent product can be directly used as a fuel.

The absorbent composition may take on the form of a fine powder or small lumps. In general, small particles absorb oil more rapidly than larger ones, but large particles will float for longer periods of time because the air trapped inside them allows them to stay buoyant for longer. Whereas this seems an advantage, the effectiveness of the composition to absorb oil decreases rapidly once water is absorbed. In embodiments where the composition has not been treated with a water repellent substance, it is important that the composition is directly applied to an oil spill to prevent absorption of water before the oil is contacted by the composition.

The mean particle size of the absorbent composition may therefore be of any size, but a particle size between 0.01 mm and 50 mm, or between about 0.01 mm and 25 mm, or between about 0.1 mm and 10 mm, or between 0.1 mm and 5 mm, or between 0.1 mm and 1 mm is effective. In one embodiment, the mean particle size may be less than 2 mm, or less than 1 mm, or less of than 0.5 mm, or less than 0.1 mm, or less than 0.01 mm. In another embodiment, the mean particle size of the absorbent composition may be greater than 2 mm, 3 mm, 4 mm, or greater than 5 mm. Larger particles are easier to handle and can be dropped onto an oil spill much easier than small particles which can easily blow away before they reach the spill. Furthermore, finely powdered charcoal can present an explosion hazard when stored in a closed environment. Therefore, it is preferred that the particles are greater than at least 1 mm.

To prevent formation of charcoal dust that can be easily blown away, in a further aspect, it is preferred that the compositions of the second and third aspects of the invention may be treated with a small quantity of oil, for example up to 10% of the biochar weight. Thus, the composition may comprise up to 10% (w/w) oil. Oil used for this purpose may be mineral oil or vegetable oil.

To prevent the composition taking up water, in a further embodiment the composition may be treated with a water repellent substance. This may involve contacting the char with hot paraffin gas, melted fat or heating of char that has been allowed to absorb oil to remove any liquid or volatile fractions. Thus, the oil absorbent composition may comprise a water repellent substance. The water repellent substance may comprise lipid. For example, the repellent may be selected from the group consisting of: a fat; animal fat; plant fat; a fatty acid; a fatty acid ester; a fatty alcohol; a glyceride (mono-, di- or tri-glyceride); a hydrocarbon, such as a paraffin wax or tar; and mineral tar.

In another embodiment, the absorbent composition may comprise a mixture of differently sized particles. For example, the inventors have found that a mixture of absorbent particles less than about 0.5 mm and particles larger than about 5 mm surprisingly results in the particles sticking together in large rafts making it easy to remove the absorbed oil using nets or booms. Therefore, the composition may comprise a mixture of absorbent particles having a mean particle size of between about 0.01 and 0.5 mm (i.e. small particles) and between about 5 mm and 100 mm (i.e. large particles). The ratio of smaller to larger particles sizes may be between 1:10 and 10:1, or between 1:5 and 5:1, or between 1:3 and 3:1, and most suitably between 1:2 and 2:1. The ratio of smaller to larger particles sizes is preferably about 1:1. An added advantage of using a mixture of particle sizes is that the larger particles will stay afloat longer than the smaller ones, while the smaller particles (because of their relative large surface area) will absorb the oil more readily.

In one embodiment, the absorbent composition may be magnetic, and so may comprise, non-valent iron, iron oxide or iron hydroxide. It will be appreciated that the resultant material will exhibit magnetic properties allowing it to be removed effectively from oil/water mixtures using magnets. The skilled person will appreciate that there are several methods by which iron-oxide/hydroxide may be incorporated into the charcoal absorbent composition. For example, the charcoal may be contacted with, or soaked in, a solution containing FeSO₄.7H₂O. Once soaked into the charcoal, the charcoal may then be removed from the solution and dried. Subsequently, the charcoal may be contacted with a solution of NaOH (e.g. 1M), which will cause the sulphate ions to be replaced by hydroxide ions. The amount of iron hydroxide within the biochar composition can be increased by soaking the charcoal in a more concentrated solution of FeSO₄.7H₂O. Clearly, incorporation of iron (oxide/hydroxide) into the composition will increase the mineral content of the composition. Preferably, the iron oxide or iron hydroxide is incorporated to a level where it does not cause the absorbent particle to become so heavy that it sinks. This feature would make it ideal for the removal of oil, for example from oil-contaminated water (e.g. bilge water), by first contacting the composition with the contaminated water allowing it to absorb the oil, and then passing the water past a strong (e.g. electro-) magnet to which the absorbent composition, and absorbed oil, will be attracted. This feature would prevent clogging of sieves or filters designed to remove oil or particles.

Advantageously, the absorbent composition enhances the degradation of an oil slick by allowing oxygen to penetrate into the oil slick, as the product works like a bulking agent. Hence, in another embodiment, the absorbent composition may comprise an oxygen-releasing agent, such as magnesium peroxide or calcium peroxide. This can be achieved by mixing the composition simply with a peroxide powder which would be applied together onto an oil spill. As the charcoal binds the oil together in aggregates, the peroxide is incorporated into the mixture. As the peroxide releases oxygen, it helps to enhance aeration, and therefore natural attenuation, of the oil.

In a further embodiment, the absorbent composition may be mixed with slow release fertilisers that contain nitrogen (ammonium nitrate for example), phosphate, or potassium, and/or a selection of micro-nutrients, such as Fe, Cu, Co and Zn, as well as vitamins to enhance the growth of hydrocarbon-degrading microorganisms. The charcoal composition will enhance the incorporation of these fertilisers into the oily aggregates that are formed as a result of the addition of the charcoal to an oil spill. In cases where the oil is not recovered from the water surface, these nutrients help to overcome any shortages of minerals necessary for the degradation of the different hydrocarbons that make up the oil.

In yet another embodiment, the absorbent composition may be inoculated with a community of oil-degrading bacteria. For example, the bacteria may be isolated from a marine environment that has been previously contaminated with oil. Suitable oil-degrading bacteria may belong to genera such as Pseudomonas, Bacillus, Staphylococcus, Acinetobacter, Kocuria and Micrococcus. The preferred microbial genus may be Bacillus. Not only are there extremely effective hydrocarbon degraders within this genus, but this genus produces endospores that resist desiccation and extremes of temperatures. Therefore, adding the hydrocarbon-degrading microbes as endospores will allow long-term survival of the preparation when the product is stored and rapid establishment once the product is applied.

As described herein, the absorbent compositions of the invention can be applied in a range of different scenarios for absorbing oil from water, e.g. oil slicks.

Thus, in a fourth aspect, there is provided use of the oil absorption composition according to either the second or third aspect, for absorbing oil.

The oil may be mixed with an oil-contaminated material, such as a fluid, or sand. The oil in the contaminated material may be emulsified.

In a fifth aspect, there is provided a method for absorbing oil from an oil-contaminated material, the method comprising contacting an oil-contaminated material with the oil absorption composition according to either the second or third aspect, and allowing the oil to be absorbed by the composition.

The oil-contaminated material may be a fluid, such as water. For example, the composition may be spread or sprayed on top of an oil spill on water, which results in the formation of oil/composition aggregates.

The oil-contaminated material may be oil-contaminated sand, bituminous sand or process waters. Process waters contaminated with oil may be cleaned and dispersed oils can be removed from suspension by contacting with the composition of the invention especially in embodiments where the composition is made hydrophobic by contacting with a water repellent substance.

The method may comprise a step of separating the oil absorption composition from the oil-contaminated material. For example, the separation step may comprise use of a sieve, suction sweeper, a fine-meshed net or a magnet, a mop consisting of ropes or any other physical device designed to remove oil from a water surface. Alternatively, the composition may be used as a filter material through which oil contaminated water is passed.

The method may comprise a step of recovering the absorbed oil from the absorbent composition. One method for recovering the oil from the composition would be to process (i.e. refine) the adsorbed oil as if it were pure crude oil using distillation. In an oil refinery, the composition and its absorbed oil would be heated and the different fractions collected for further use. The charcoal being non-volatile would end up in the tar fraction. Alternatively, an emulsifying agent may be added to release the oil from the composition or the oil may be recovered using centrifugation.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying diagrammatic drawings, in which:—

FIG. 1 is a graph showing the correlation between charcoal density and oil uptake;

FIG. 2 shows a SEM micrograph of the macropore structure of sweet chestnut charcoal which has been charred at 450° C.;

FIGS. 3A-3D show photographs of oil recovery using charred cellulose material. FIG. 3A: oil on water, FIG. 3B: following treatment, FIG. 3C: treated water after being passed through a 500 μm sieve, FIG. 3D: oil/char residue on the 500 μm sieve;

FIGS. 3E-3F show photographs of oil recovery using Treatment 7 vs Treatment 2. FIG. 3E: Treatment 7 involves adding an emulsifier to sand and oil, followed by the addition of water, and then charcoal. FIG. 3F: Treatment 2 involves adding charcoal after the emulsifier has emulsified the oil out of the sand;

FIGS. 3G-3J show photographs of the recovery of oil from sands. FIG. 3G: Treatment 7-Control; Sand, Oil, Water; FIG. 3H: Emulsifier added to the material referred to in FIG. 3G; FIG. 3I: Sweet Chestnut Charcoal added to the material referred to in FIG. 3H; FIG. 3J: the material of FIG. 3I left for 2 weeks;

FIGS. 3K-3N show photographs of a step-by-step process of the recovery of oil from sand. FIG. 3K: Oil added to sand, and then water added; FIG. 3L: Emulsifier added to the material referred to in FIG. 3K (Note the oil emulsifying into the water); FIG. 3M: Oil fully emulsified out of the sand into the water; FIG. 3N: Sweet Chestnut charcoal added to the material of FIG. 3M (Note oily aggregates floating on surface); and

FIG. 4 shows removal of emulsified oil using a hydrophobic oil absorbent composition which has been treated with paraffin.

### EXAMPLES

### Introduction

Charcoal is a porous material that is slightly hydrophobic. When derived from wood, the structure of the charcoal reflects the macroporous structure of the wood from which it is derived. Pyrolysis leads to around 70% mass loss of the wood and results in a structure that is >90% void. However, macropores within the charcoal are lost when the charcoal is ground up, leaving a carbon structure that consists mainly of meso- and micro-pores. In non-activated carbons, the volume of meso- and micro-pores is normally relatively small such that the solid fraction of pyrolysed wood consists mainly of graphite-like materials.

Sea-sweep, which is described in U.S. Pat. No. 5,110,785, is an oil-absorbing product derived from torrified pine wood, and claims to rely mainly on the macroporous nature of the material to absorb oil. Although not wishing to be bound by theory, the inventors hypothesised that the macropores of wood are relatively unimportant for charcoal's ability to absorb oil, and instead it was hypothesized that the pyrolysed carbon itself is responsible for absorbing oil by acting as a ‘binding agent’ that results in the formation of oily aggregates. How effective different charcoals are at forming such aggregates was, however, unknown.

A common method for treating oil spills is to apply dispersants or emulsifiers which form macro- and micro-sized droplets of oil in suspension within waters. Such emulsifiers have been shown in some cases to cause toxicity to aquatic life. The inventors therefore believe that the charcoal-containing compositions of the invention would absorb emulsified oil from waters. Furthermore, the inventors have demonstrated that removal of the charcoal/emulsified oil is effective. There is also potential for testing using standard eco-toxicity to demonstrate that the captured emulsified oils are less environmentally damaging than their non-absorbed counterparts.

Soils, beach and sea-bed sands and estuarine muds are commonly impacted by oil spills, and washing or submersion within water does little to release the absorbed oil. However, the application of a washing process with an appropriate emulsifier or a dispersing agent can be used to release the soil/sand-absorbed oils into suspension within water. The inventors have therefore tested the ability of the charcoal compositions of the invention to remove oil in suspension within such material washings.

Lastly, the inventors have also tested whether the charcoal-containing compositions of the invention can be used with emulsifiers to remove oil from oil sands. Accordingly, the inventors believe that the charcoal-oil mix can be pre-processed (i.e. upgraded) to a refinery standard.

### Materials and Methods

### Importance of Macropores for Oil Absorbance

To assess if macropore volume is a significant factor in oil uptake, the density of charcoals derived from different wood species was assessed. A charring temperature of 450° C. was used. The material was heated for approximately 2 hours to ensure complete pyrolysis of the wood. First, a lump of charcoal was weighed, and it was then soaked in oil to make the lump hydrophobic and incapable of soaking up water. Excess oil was removed by washing the oil-soaked lump of charcoal under a tap of water. The lump of charcoal was then attached to a needle and the volume of the lump was measured using water displacement. To achieve this, a measuring cylinder was filled with water and the oil-soaked lump of charcoal was pushed below the water surface, and the increase in volume was recorded. Density was expressed as weight of charcoal/volume of charcoal. Oil absorbance was subsequently correlated with wood density. It was expected that since most of the ‘void spaces’ are macropores, there would be a strong correlation between wood density and oil absorbance.

To test if macropore structure of wood-derived charcoals was important for the absorption of oil from a water surface, Paulownia wood that was charred at 450° C., was ground with a pestle and mortar and passed over a nest of three sieves; 500 μm, 150 μm and 60 μm sieve to obtain four size classes of charcoal (<60 μm, 60-150 μm, 150-500 μm and >500 μm). Grinding will destroy the macropore structure of a charcoal such that the largest particles had an almost intact macropore structure, while the smallest size class consisted mainly of charcoal charts with few intact pores.

To test the role of macropores for oil absorbance of the different charcoal particles, a 250 ml Duran bottle was filled with approximately 100 ml water. The bottle with water was placed on a balance and tarred to zero. Subsequently, 1 g of oil was dropped onto the water surface. Charcoal was added slowly on top of the oil with intermittent swirling of the water to speed up the process of bringing the charcoal into contact with the oil. This process was continued until all of the oil was absorbed from the surface of the water. The minimum amount of charcoal needed to absorb all of the oil was recorded. Treatments were replicated three times and the results were analysed using ANOVA. Significant differences between treatments were assessed using Tukey's test for significant differences between pairs of treatments.

### Effect of Source Material on Absorbance of Oil

Absorption of charcoals derived from eleven different source materials (Papier-mâché, Mount-board, cellulose sponge, Barley Straw, Oil-Seed Rape straw, Ash Wood, Beech Wood, Paulownia Wood, Sweet Chestnut Wood, Spruce Wood, Pine Wood, Cyprus Wood, and Oak Wood) were tested. Furthermore, both the charcoals derived from barley straw and oilseed rape straw were acid-washed in hydrochloric acid (pH<1) to remove the minerals that were associated with these chars. Hence, a total of 15 materials were tested for their ability to absorb oil using the method described above.

Recovery of Oil from Water

The ability to recover oil from water using the above method was tested by passing the absorbed oil+water over a pre-weighted 500 μm sieve, removing excess water using a paper towel and then further air drying for an hour before weighing the sieve and the charcoal/oil deposit. For experimental purposes, a 500 ml Duran bottle containing 200 ml water was amended with 3 g oil and 0.5 g product. Because the theoretical weight of the combined oil and charcoal was known (3.5 g) and assuming that no oil was left in the water (which was clear) an estimate could be made of how much water was taken up by the charcoal. Only the best materials (demineralised barley straw, demineralised oilseed rape straw and papier-mâché) were tested in triplicate.

Recovery of Emulsified Oil from Water

The ability of 5 g charcoal product to remove emulsified oil from waters was tested. For experimental purposes, a 500 ml beaker was used containing 250 ml water amended with 5 g oil emulsified into suspension within the water with 5 g emulsifying agent (Decon 90). A visual assessment of the absorption of the emulsified oils by the charcoals was made. Both barley straw and sweet chestnut chars were tested in triplicate to compare the effects of the different materials.

Recovery of Oil from Sands

The ability of charcoal to absorb oil, which had been brought into suspension using an emulsifying agent so as to remove the oil from sand, was tested. For experimental purposes, a 500 ml beaker was used containing 100 g sand (laboratory grade), two oil treatments (5 g and 10 g), submerged in 200 ml water with 5 g emulsifying agent (Decon 90) added (compared to control, zero g of emulsifying agent) and amended with 5 g and 10 g charcoal product. Both barley straw and sweet chestnut chars were tested in triplicate to compare the effects of the different materials. Visual assessments of oil absorption were made on the following treatments:

| Treatment | Sand/ | Crude | Wa- | Emulsifier | | Char- |
|---|---|---|---|---|---|---|
| No. | g | Oil/g | ter/g | (Decon 90)/g | Charcoal | coal/g |
| 1 | 100 | 10 | 200 | 5 | Sweet | 10 |
| | | | | | Chestnut | |
| 2 | 100 | 5 | 200 | 5 | Sweet | 5 |
| | | | | | Chestnut | |
| 3 | 100 | 5 | 200 | 5 | Barley | 2 |
| | | | | | Straw | |
| 4 (Control) | 100 | — | 200 | 5 | Sweet | 5 |
| | | | | | Chestnut | |
| 5 (Control) | 100 | 5 | 200 | — | — | — |
| 6 (Control) | 100 | 5 | 200 | 5 | — | — |

A further treatment was tested (referred to here as Treatment No. 7). The inventors tested the ability of the emulsifying agent, when mixed directly with the oil impacted sand, to suspend the oil when water was added. For experimental purposes, a 500 ml beaker was used containing 100 g sand (laboratory grade), 5 g of crude oil, with 5 g emulsifying agent (Decon 90) submerged in 200 ml water and amended with 5 g of sweet chestnut charcoal.

Biodegradation of Captured Oil within Charcoal:

Here we left the oil impregnated charcoal (100 g sand, 10 g oil, 5 g emulsifying agent, 200 ml of water, 10 g sweet chestnut char treatment from Experiment 2.5) for 14 days in a covered beaker (to prevent evaporative losses of volatiles) and conducted a visual assessment of oil absorbed by the char.

### Results

### Importance of Macropores for Oil Absorbance

FIG. 1 shows that there is a weak negative correlation (r²=0.790) between charcoal density and oil uptake. However, there is a general trend that ‘low density’ chars are better at taking up oil than ‘high density’ chars. None of the high density woods were particularly absorbent. Whereas this indicates that macropore structure could play a role in oil uptake, the inventors do not believe that it is the only factor.

TABLE 1
Effect of charcoal particle size on absorption of oil.
Paulownia wood with size classes of >500 μm, between
500 and 150 μm, 150 and 60 μm and <60 μm were used.

| Particle size (μm) | Absorbance (ml/g) |
|---|---|
| >500 | 4.58 |
| 150-500 | 4.44 |
| 60-150 | 4.39 |
| <60 | 4.44 |
| Significance | Not significant |

Table 1 shows that grinding the charcoal to particles<60 μm had no significant effect on the charcoal's ability to take up oil, suggesting that the hydrophobic properties of the charcoal itself were in the main responsible factor for oil absorbance and that macropores were in the main not involved.

It could be argued that, because macropores in wood are normally around 10-15 μm in diameter (see FIG. 2), charcoal pieces with a diameter of <60 μm could contain some macropores. On the other hand, such pores would be very short, giving them next to no capillary action.

### Effect of Source Material on Absorbance of Oil

A variety of different source materials were tested for their oil absorbance capabilities.

TABLE 2
Oil absorbance of charcoals derived from
different source materials. N = 3

| | | |
|---|---|---|
| Source material | Oil uptake (l kg⁻¹) | SE |

Cellulose materials

| | | |
|---|---|---|
| Barley Straw | 7.97 | 0.328 |
| Barley Straw | 9.53 | 0.281 |
| De-mineralised | | |
| Oilseed Rape Straw | 5.35 | 0.329 |
| Oilseed Rape Straw | 7.81 | 0.467 |
| De-mineralised | | |
| Papier-mâché | 10.16 | 0.537 |
| Cellulose sponge | 9.25 | 0.000 |
| Mount board | 2.50 | 0.046 |

Lignin containing materials
(Soft woods)

| | | |
|---|---|---|
| Spruce | 3.37 | 0.056 |
| Pine | 3.74 | 0.044 |
| Cypress | 3.09 | 0.089 |

Lignin containing materials
(Hard Woods)

| | | |
|---|---|---|
| Paulownia | 4.44 | 0.089 |
| Beech | 3.39 | 0.100 |
| Sweet Chestnut | 1.96 | 0.056 |
| Ash | 1.99 | 0.056 |
| Oak | 1.29 | 0.022 |
| P | *** | |

Table 2 shows that there are large differences in the ability of different charred materials to absorb oil, with charred papier-mâché capable of taking up >10 Litre oil per kg material while charred oak wood was only capable of absorbing 1.3 Litre oil per kg char.

De-mineralisation of chars derived from oilseed rape straw led to a 32% (P<0.001) increase in oil absorbance per unit weight and a 16% (P<0.05) increase in oil absorbance for char derived from barley straw. This is almost exactly proportional to the mineral contents of the source materials (mineral content barley char: 15% and mineral content of oil seed rape char 30.3%).

Chars derived from materials with a high cellulose content (papier-mâché, demineralised oilseed rape, cellulose sponge and demineralised barley straw) were on average 3 times more effective at absorbing oil than chars derived from wood. However, charred mount board was similar in its effectiveness of absorbing oil as charred wood. Interestingly, the density of charred mount board was around 0.42 g/ml which is almost twice as dense as wood, while for example charred cellulose sponge had a density of 0.13 g/ml. Therefore, for a char to take up maximum amounts of oil, the char needs to be arranged in a loose structure that provides a maximum amount of void space, and most materials that are rich in cellulose seem to fit this characteristic.

Recovery of Oil from Waters

The inventors tested the efficacy for various oil absorbent materials to release absorbed oil. Referring to FIGS. 3A-3D, there are shown photographs of oil recovery using charred cellulose material. FIG. 3A: shows the oil dispersed on the water surface, and shows the water following treatment with the composition of the invention. FIG. 3C shows the treated water after being passed through a 500 μm sieve, and FIG. 3D shows the oil/char residue on the 500 μm sieve.

TABLE 3
Oil recovery using charred (and demineralised)
barley straw and charred papier-mâché.
0.5 g material was used to absorb 3 g oil

| | | Percentage | |
|---|---|---|---|
| Source material | Total weight | recovery | SE |
| Demin Barley | 3.45 | 99% | 0.02 |
| Papier-mâché | 3.43 | 98% | 0.03 |
| significance | NS | NS | |

Table 3 shows that a large percentage of oil was recovered using charred and de-mineralised barley straw or charred papier-mâché. Whereas it is possible that part of the combined weight of the char and oil consisted of water, this is unlikely as there was no visible oil left in the water, as shown in FIGS. 3A-3D. The small loss of oil and carbon can be contributed to a small proportion of particles of char and oil passing through the 500 μm sieve. Assuming that the char and oil that was recovered on the sieve contained no water, the method described here holds a lot of promise to recover oil spills.

Recovery of Emulsified Oil from Waters

A visual assessment of the treatments revealed that larger aggregates of charcoal (sweet chestnut charcoal) floated in comparison to barley straw, whereas a larger proportion of the charcoal sank. The sweet chestnut charcoal would therefore make for easier recovery. The water became significantly clearer after addition of both of the charcoals. The amount of absorbed oil seemed to be comparable in both charcoals, although the higher mineral content of the barley charcoal made the water darker, therefore making a visual comparison difficult.

Recovery of Oil from Sands

The inventors investigated the recovery of sand-absorbed oil. Referring to FIGS. 3E-3F, there are shown photographs of oil recovery using Treatment 7 (i.e. FIG. 3E) vs Treatment 2 (i.e. FIG. 3F). Treatment 7, shown in FIG. 3E, involves adding an emulsifier to sand and oil, followed by the addition of water, and then charcoal. Treatment 2, shown in FIG. 3F, involves adding charcoal after the emulsifier has emulsified the oil out of the sand. As can be seen, Treatment 2 (5 g of sweet chestnut charcoal) was the most successful with large oil aggregates floating on the surface. The water was transparent in comparison to the control. Treatment 7 (Emulsifier added to sand and oil) was less successful and the charcoal did not recover as much oil, and more oil remained in the water.

Referring to FIGS. 3G-3J, there are shown additional photographs of the recovery of oil from sands. Treatment 7, i.e. sand, oil and water, is shown in FIG. 3G, and acted as the control. In FIG. 3H, emulsifier was added to the mix shown in FIG. 3G. In FIG. 3I, sweet chestnut charcoal added to the mix shown in FIG. 3H. Finally, FIG. 3J shows what happens to the mix shown in FIG. 3I if left for 2 weeks to stand.

Referring to FIGS. 3K-3N, there are shown photographs of a step-by-step process of the recovery of oil from sand. FIG. 3K shows oil added to sand, and then water added. FIG. 3L shows the effect of adding emulsifier to the mix shown in FIG. 3K. It should be noted that the oil emulsifies into the water. FIG. 3M shows oil fully emulsified out of the sand into the water, and FIG. 3N shows Sweet Chestnut charcoal added to the mix shown in FIG. 3M. It should be noted that oily aggregates can be seen floating on the water's surface.

The Degradation of Oil Captured within the Charred Materials

Over a 2 week period, the water in Treatment 2 became much clearer and the charcoal oily aggregates appeared to be separated from each other. When agitated, the oil was not released back in to solution. The oil was now permanently bound to the charcoal. Over time, microbial action has degraded the oil further and the crude oil odour had virtually gone in comparison to a very strong odour at the beginning of the experiment.

### Mineral Content of Different Source Materials

### Materials and Methods

The mineral content of seven different hardwood species (ash (Fraxinus excelsior), birch (Betula spp), beech (Fagus sylvatica), sweet chestnut (Castanea sativa), poplar (Populus spp.), and oak (Quercus robur)), five soft wood species (spruce (Picea spp), pine (Pinus silvestrus), cyprus (Cyprus spp) and larch (Larix decidua) and five non-woody plants (Nettle (Urtica dioica), beet leaves (Beta spp), wheat straw (Triticum aestivum), barley straw (Hordeum vulgare) and oil seed rape straw (Brassica napus) was determined using the following procedures.

Demineralisation of charcoals was carried out by weighing 10 g of ground charcoal and suspending this in 500 ml nitric acid. The pH of the suspension was adjusted to pH 1 and the suspension was left for 24 hours with intermittent stirring to ensure that all dissolvable minerals were removed. The acid was removed by filtering the suspension using suction filtration. The charcoal on the filter paper was washed with distilled water three times to remove all acid.

### Charcoal Preparation

Charcoals were prepared at 450° C. for 6 hr in a Carbolite LMF 4 furnace. Starting materials were wrapped in several layers of aluminium foil prior to charring to exclude air. Wood charcoals were prepared from trunk wood with a diameter of >15 cm that had been air dried. Non-woody materials were dried overnight at 105° C.

### Ash Content

Ash content of the charcoals was determined using British Standard Method (BSI 2004). Briefly, a heatproof crucible was heated to 550° C. for 1 hr and then allowed to cool completely in a desiccator. The crucible was weighed and approximately 1 g of charcoal (<500 μm particle size) added. The charcoal was oven dried at 105° C. for 24 hr, cooled in a desiccator, weighed and then ashed overnight at 550° C. The ash was cooled in a desiccator without desiccant and weighed. The percent ash content was determined using [(m₃−m₁)/(m₂−m₁)]×100, where m₁ was the mass of the crucible, m₂ was the mass of the crucible and dried charcoal and m₃ was the mass of the ash and crucible. All measurements were carried out in triplicate.

### Mineral Content

To determine the mineral content of the different charcoals an aqua-regia digest was prepared followed by an elemental analysis using ICP-OES. Samples were accurately weighted into 15 cm³ quartz tubes and stored in a heat proof rack. Samples were ashed at 460 C for 18 hours. After cooling 0.75 cm³ concentrated nitric acid followed by 2.25 cm³ concentrated hydrochloric acid were added to each sample and left for 12 hours.

Subsequently the tubes were heated for 1 hour at 50 C and at every temperature increment (70, 90 C) till yellow nitrous oxide clears and then finally for a further 2 hours at 110 C. After cooling 0.40 cm³ H₂O₂ was added and samples were heated for a further 30 minutes at 110 C, this process was repeated once more. Finally samples were made up to 15 cm³ with water and stored for analysis.

### Results

TABLE 4
Average mineral (K, Ca, Mg and Na) and ash content of
19 different source materials (n = 2)

| | Mineral content (%) | | | | | Ash content |
|---|---|---|---|---|---|---|
| Source material | K | Ca | Mg | Na | Total | (%) |

Hard woods

| | | | | | | |
|---|---|---|---|---|---|---|
| Ash | 0.460 | 1.596 | 0.089 | 0.007 | 2.15 | 4.3 |
| Beech | 0.208 | 0.288 | 0.052 | 0.013 | 0.56 | 1.1 |
| Sweet Chestnut | 0.406 | 1.010 | 0.171 | 0.012 | 1.60 | 3.6 |
| Poplar | 0.680 | 1.747 | 0.238 | 0.005 | 2.67 | 7.0 |
| Willow | 0.560 | 1.769 | 0.115 | 0.006 | 2.45 | 6.0 |
| Oak | 0.667 | 1.663 | 0.086 | 0.015 | 2.43 | 5.7 |

Soft woods

| | | | | | | |
|---|---|---|---|---|---|---|
| Spruce | 0.188 | 0.165 | 0.013 | 0.014 | 0.40 | 1.66 |
| Pine | 0.215 | 0.329 | 0.070 | 0.003 | 0.62 | 1.67 |
| Cyprus | 0.284 | 0.924 | 0.044 | 0.003 | 1.26 | 3.33 |
| Larch | 0.184 | 0.138 | 0.031 | 0.004 | 0.36 | 0.60 |

Non-woody plants

| | | | | | | |
|---|---|---|---|---|---|---|
| Nettle | 14.047 | 3.909 | 0.922 | 0.056 | 18.93 | 47.3 |
| Barley straw | 3.057 | 2.071 | 0.159 | 0.085 | 5.37 | 14.0 |
| Wheat straw | 3.266 | 0.942 | 0.129 | 0.093 | 4.43 | 12.7 |
| Beet leaves | 11.631 | 3.836 | 1.253 | 4.272 | 20.99 | 50.0 |
| Oilseed rape | 5.087 | 4.813 | 0.119 | 0.206 | 10.22 | 34.0 |
| straw | | | | | | |

Demineralised samples contained <0.1% of either K, Ca, Mg or Na and had ash contents of <2%.

### Conclusions

Based on their experiments, the inventors have concluded that:—
1) Charred cellulose materials that have a low density are capable of absorbing or absorbing up to 9× their own weight in oil.
2) Oil absorbing capability of charred and demineralised straw (i.e. non-woody) is 3× greater than charred wood;
3) Continuous macropores play no or only a minor role in the uptake of oil, but char density is a significant factor that determines oil absorbance;
4) Uptake of oil is governed by the slightly hydrophobic properties of charred carbon;
5) Charcoal (preferably derived from low density cellulose containing materials) binds oil together to form floating aggregates that are easily removed from the water's surface using a fine sieve, net or some other suitable mechanical removal device;
6) Char applied on top of an oil spill will take up oil preferentially resulting in oil/char aggregates that contain little or no water;
7) Charred source materials that are particularly useful for oil recovery are those that are of low density, such as charred paper or straw;
8) Removal of minerals from the charred straw enhances the ability of the char to absorb oil equivalent to the mineral content of the charred biomass; for barley straw this figure is 15%, for oilseed rape straw 30% and for nettle straw it is 50%.
9) Use of de-mineralised char for oil recovery would be beneficial as the oil/char can be processed as normal crude oil;
10) Pre-treatment with small quantities of mineral or vegetable oil will prevent the composition forming a dust, thus increasing ease of application and preventing explosion hazards associated with fine powdered materials;
11) Addition of peroxides with the composition will result in the formation of aerated oily aggregates after application to an oil spill. Aeration of the oil will enhance the establishment and growth of oil degrading micro-organisms, either by stimulating those that are naturally present in the environment or ones that are added to the preparation;
12) Precipitation of iron hydroxides within the charcoal will result in the charcoal becoming ‘magnetic’ and therefore allowing the composition to be removed from the environment using magnets;
13) Addition of slow-release fertilisers and vitamins to the composition will result in a product that allows these minerals to become incorporated into the oily aggregates, thus enhancing the establishment and growth of oil degrading micro-organisms, either by stimulating those that are naturally present in the environment or ones that are added to the preparation;
14) Addition of oil-degrading microbes, especially those of the genus Bacillus, will allow rapid establishment of an oil degrading culture;
15) Oil which has been emulsified within waters is effectively absorbed by the charcoal products;
16) Sands contaminated with oil can be cleaned by introducing an emulsifying agent and water, and the subsequently emulsified oils can be removed from suspension from within the water by amendment with charcoal product;
17) Visual assessments showed that a large proportion of the emulsified oil which had been absorbed by the charcoal effectively degraded within 14 days with no further amendments. There is potential to enhance such degradation through amendment with nutrients (e.g. N, P, K, Mg, Ca) or oxidizing agents (e.g. peroxides) and/or environmental improvements (e.g. aeration, moisture control).
   Oil Absorption of Char Impregnated with Paraffin

### Introduction

Charcoal is slightly hydrophobic but, when contacted with water, the water will normally penetrate rapidly into the charcoal. This leads to the voids inside the char becoming occupied with water, preventing the uptake of oil. Also, because the specific gravity of carbon (without the voids) is greater than 1, charcoal will sink when put into water before it has had the chance to take up oil. As oil normally floats on water, this will prevent further contact between water and charcoal. In situations where the oil is dispersed in the water at low concentrations, natural charcoal will absorb mainly water, making natural char relatively ineffective for the removal of dispersed oil.

There was therefore a need to develop a method that increased the hydrophobicity of the charcoal significantly, without negatively impacting on the absorption capacity of the char. Paraffin wax is solid at room temperature and has a melting point of 56° C. Above 150° C., it is a gas. Paraffin gas easily penetrates into the voids, where it is adsorbed into the charcoal's micro and meso-pore structure. Once cooled, paraffin will solidify thus forming a coating onto the inner charcoal surfaces.

The following experiments were set up to test the effectiveness of paraffin-treated charcoal for oil absorption, if initially contacted with water.

### Materials and Methods

Impregnation of Char with Paraffin

To impregnate char with paraffin, 10 g paraffin wax was placed at the bottom of a 1500 ml stainless steel container (30 cm length; 8 cm diameter) that could be closed with a tight fitting, but not air tight, steel cap. This allowed gases that were formed to be released without allowing gases from outside the container to get into the container. The container was filled with demineralized barley straw char that had been charred at temperatures>800° C. The particle size of the char was between 0.1 and 2 mm. Subsequently, the closed container filled with char was placed at a slight angle of 15 degrees inside a muffle furnace (Carbolite, UK) and heated at 200° C. for 1 hour. The char was then left to cool overnight. By shaking samples of the thus treated char with water, hydrophobicity of the char could be assessed. It was found that the top layer was not as hydrophobic as the bottom layers, and as a result, the char taken from the bottom half of the container was used for the following tests.

### Absorbance of Oil

To compare the maximum oil absorbance of paraffin-treated and non-treated char, 250 ml beakers filled with approx. 100 ml water were used. A beaker with water was placed on a balance and tarred to zero. Subsequently approx. 1 g of oil (Kuwait Crude) was dropped onto the water surface and the exact weight of the oil added was recorded. Subsequently, charcoal was added slowly on top of the oil with intermittent swirling of the water to speed up the process of bringing the charcoal into contact with the oil. This process was continued till all oil was absorbed from the surface of the water. The minimum amount of charcoal needed to absorb all the oil was recorded and the absorbance of the char calculated by dividing the amount of oil absorbed by the amount of char added. Treatments were replicated three times and the results were analysed using ANOVA.

To test the oil absorption of the char when contacted with water first, a 250 ml beaker containing approx. 100 ml water was placed on a balance and tarred to zero. Between 0.2 and 0.3 g of char was added to the water, and the exact quantity of char added was recorded. The char was left for approx. 5 minutes in the water to allow interaction with the water to take place. Subsequently, crude oil (Kuwait Crude) was added to the beaker till the char would take up no more oil. Paraffin-treated and non-treated char were compared and each treatment was replicated three times. The maximum amount of oil added was recorded for each replicate and the maximum absorbent capacity of the char was calculated. Results were analysed using ANOVA.

The test was repeated using salt water (3.5% NaCl) simulating absorbance of oil from sea water. Results were compared with those obtained with fresh water.

### Absorbance of Emulsified Oil

A qualitative test was set up to assess if paraffin-treated barley char was capable of removing emulsified Kuwait Crude oil. Oil was emulsified in water using ‘Decon’ (approx. 2 ml Decon to emulsify 5 g oil). The emulsified oil was subsequently divided into two 500 ml beakers each containing around 150 ml emulsified oil. To break up the dispersant, the pH of the emulsion was lowered to 1 using concentrated hydrochloric acid. Approx 1 g of paraffin treated barley char was added to one beaker and the beakers were left for 8 hours with occasional shaking. Removal of emulsified oil was assessed visually.

### Results

Absorbance of Oil from Water Using Paraffin and Non-Paraffin Treated Barley Char

TABLE 5
Comparison of maximum oil absorption of paraffin treated
demineralized barley char (paraffin treated DBC) and non-
treated, demineralized barley char (DBC). Absorption of char
applied on top of the oil was compared to application of
oil to char that was added to the water first. Results are
expressed as g oil absorbed by 1 g char ± SE. N = 3.

| | Oil absorption (g oil g⁻¹ char) | | |
|---|---|---|---|
| Treatment | Oil added first | Char added first | P |
| DBC | 7.57 ± 0.09 | 0.31 ± 0.07 | <0.001 |
| Paraffin treated | 5.23 ± 0.16 | 5.63 ± 0.70 | NS |
| DBC | | | |
| P | <0.001 | <0.001 | |

Impregnation of char with paraffin reduced the maximum oil absorbent capacity of the char by around 30% (P<0.001). However, when added to water first the oil absorbance of non-paraffin treated char declined rapidly to less than 4% of its original oil absorbent capacity. Paraffin-treated char remained effective at absorbing oil from water with no significant decline in absorbance. As a result, paraffin-treated char took up 18 times more oil from the water than non-paraffin treated char (P<0.001) when the char was contacted with the water first (Table 5).

TABLE 6
Comparison of oil absorption by paraffin treated demineralized
barley char from salt water (3.5% NaCl) compared with
oil absorption from fresh water. Results are expressed
as g oil absorbed by 1 g char ± SE. N = 3.

| | Oil absorption (g oil g⁻¹ char) | | |
|---|---|---|---|
| Treatment | Oil added first | Char added first | P |
| Fresh Water | 5.23 ± 0.16 | 5.63 ± 0.70 | NS |
| Salt Water | 5.32 ± 0.64 | 4.80 ± 0.51 | NS |
| P | NS | NS | |

There was no significant difference in oil absorption of paraffin-treated demineralized barley char from salt or fresh water, irrespective if the oil was added first or if the char was added first to the water (Table 6).

Absorbance of emulsified oil from water using paraffin treated barley char Referring to FIG. 4, there is shown the removal of emulsified crude oil using paraffin treated barley char (labelled C-Cure-Oil in the figure). Oil was emulsified in water using ‘Decon’ (approx. 2 ml Decon to emulsify 5 g oil).

### Conclusions

Paraffin treated char is highly hydrophobic and does not absorb water. Paraffin treated char is effective at absorbing oil (>5× its weight in oil). The oil absorbance of paraffin treated char is not affected by being into contact with water. Oil absorbance of paraffin treated char is equally effective from salt water as from fresh water. Paraffin treated char is effective at removing emulsified oil.

1. A method of preparing an oil absorbent composition, the method comprising heating and then de-mineralising a precursor plant material under conditions suitable to produce an oil absorbent composition comprising charcoal.

2. A method according to claim 1, wherein the oil absorbent composition is contacted with a water repellent substance selected from the group consisting of: a fat; animal fat; plant fat; a fatty acid; a fatty acid ester; a fatty alcohol; a glyceride (mono-, di- or tri-glyceride); a hydrocarbon, such as a paraffin wax or tar; and mineral tar.

3. A method according to claim 2, wherein the water repellent substance is contacted with the oil absorbent composition such that it is adsorbed into the micropores and/or mesopores of the absorbent composition.

4. A method according to claim 2, wherein the water repellent substance is in a gaseous form when it is contacted with the oil absorbent composition.

5. A method according to claim 1, wherein the precursor material comprises, or is derived from, a hardwood species of plant, such as paulownia (Paulowniaceae spp.), aspen (Populus tremulis) and other poplar species such as cotton wood (Populus deltoides), balsa wood (Ochroma pyramidalis), Butterwood (Platanus occidentalis), walnut (Juglans regia) or willow (Salex spp.).

6. A method according to claim 1, wherein the precursor material comprises or is derived from a softwood species of tree, for example a conifer (Picea spp.), pine (Pinaceae spp.) or cedar (Cedres spp.).

7. A method according to claim 1, wherein the precursor material is derived from a plant family selected from the group of families consisting of: Brassicaceae, Poaceae, Amaranthaceae and Urticaceae, preferably derived from a genus selected from Brassica or Hordeum, for example Brassica napus (oilseed rape), Hordeum vulgare (Barley), Triticum aestivum (Wheat), Secale cereale (Rye) Myscanthus (Elephant grass) or Zea mays (Maize).

8. A method according to claim 1, wherein the precursor material is heated at a temperature of between about 280° C. and about 1200° C., or between about 350° C. and about 800° C., or between about 400° C. and about 600° C.

9. A method according to claim 1, wherein the precursor material is heated under substantially anaerobic conditions.

10. A method according to claim 1, wherein the demineralisation step is achieved by contacting the precursor material with an acid for a suitable time period to allow for the removal of mineral ions from the previously heated precursor material.

11. A method according to claim 10, wherein the acid is sulphuric acid, hydrochloric acid or nitric acid.

12. A method according to claim 10, wherein removal of elements from the oil absorbent composition is achieved by contacting the composition with a buffered solution having a neutral or a slightly acidic pH.

13. A method according to claim 1, wherein the total concentration of potassium, magnesium, calcium and/or sodium is less than 10% (w/w), less than 5% (w/w) or less than 2% (w/w) of dried material.

14. A method according to claim 10, wherein, after demineralisation, the method comprises a step of separating the resultant absorbent composition from the acid, for example by filtration or centrifugation.

15. A method according to claim 14, wherein, following separation from the acid, the method comprises adjusting the pH of the composition until the pH indicates that the majority of the acid has been substantially neutralised.

16. An oil absorbent composition comprising charred charcoal comprising, or being derived from, plant material, wherein the charcoal has a density less than 0.2 kg/L and a mineral content of less than 5% (w/w) of dried material.

17. A composition according to claim 16, wherein the oil absorbent composition comprises a water repellent substance, wherein the repellent is selected from the group consisting of: a fat; animal fat; plant fat; a fatty acid; a fatty acid ester; a fatty alcohol; a glyceride (mono-, di- or tri-glyceride); a hydrocarbon, such as a paraffin wax or tar; and mineral tar.

18. A composition according to claim 16, wherein the absorbent composition is magnetic, optionally comprising, iron, iron oxide or iron hydroxide.

19. A composition according to claim 16, wherein the absorbent composition comprises an oxygen-releasing agent, such as sodium peroxide or calcium peroxide.

20. A composition according to claim 16, wherein the absorbent composition is inoculated with a community of oil-degrading bacteria, for example belonging to genera such as Pseudomonas, Bacillus, Staphylococcus, Acinetobacter, Kocuria and/or Micrococcus.

21. A method for absorbing oil from an oil-contaminated material, the method comprising contacting an oil-contaminated material with the oil absorption composition according to claim 16, and allowing the oil to be absorbed by the composition.

22. A method according to claim 21, wherein the method comprises introducing an emulsifying agent and water, and the subsequently emulsified oils can be removed from suspension first by acidification and subsequently from the water by contacting with the composition.

23. A method according to claim 21, wherein the method comprises a step of separating the oil absorption composition from the oil-contaminated material, wherein the separation step comprises use of a sieve, suction sweeper, a fine-meshed net or a magnet, a mop consisting of ropes or any other physical device designed to remove oil from a water surface.
